(19) United States
(12) Patent Application Publication
(10) Pub. No.: US 2010/0161926 A1
(43) Pub. Date: Jun. 24, 2010

(54) Data protection by segmented storage

(76) Inventors: Hong Li, El Dorado Hills, CA (US); Hormuzd M. Khosravi, Portland, OR (US)

Correspondence Address: INTEL CORPORATION;c/o CPA Global, P.O. BOX 52050, MINNEAPOLIS, MN, 55402, US

(21) Appl. No.: 12/317,429

(22) Filed: Dec. 23, 2008

(51) Int. Cl. G06F 12/14; G06F 12/00; G06F 7/00

(52) U.S. Cl. 711/163; 711/E12.091; 707/E17.01

(57) ABSTRACT

A device, method, and system are disclosed. In one embodiment the device includes logic to handle and protect data. Specifically, the device includes logic to segment data that can receive a data object that needs to be stored. The logic within the device can segment the data object into a plurality of data segments. A segmented portion of the data object is an incomprehensible portion the data object when viewed in the segmented format. The device can then send each of the data segments to a several different storage locations.

### FIELD OF THE INVENTION

The invention relates to protecting data stored on the Internet through segmentation.

### BACKGROUND OF THE INVENTION

Internet-based distributed data storage solutions have developed significantly in recent years. One well-known solution that has been introduced is the Google™ File System (GFS). This file system includes distributing large portions of data across many computers coupled to the Internet. A simple architectural overview of the GFS includes a GFS master to interact with each of the storage computers. Each portion of the GFS stored on a given computer is referred to as a chunk. GFS chunks are relatively large (e.g. 64 Mega-bytes(MB)) which offers certain advantages. For example, when a requester needs data, many times that data may be stored in a single chunk, which would limit the overhead of interaction with the GFS master. Additionally, each chunk is stored as a plain file on the storage computer. In the GFS case, the set of chunks are generally stored at a single data center in a single geographic location. Other Internet-based distributed file systems utilize similar topologies for simplicity.

### BRIEF DESCRIPTION OF THE DRAWINGS

The present invention is illustrated by way of example and is not limited by the drawings, in which like references indicate similar elements, and in which:

FIG. 1 illustrates an embodiment of a system to store and retrieve segmented data for protection of data integrity and security.

FIG. 2 illustrates an embodiment of a computer system housing the data protection handling engine.

FIG. 3 is a flow diagram of an embodiment of a process to store and retrieve data objects in a protected segmented format in multiple locations across the Internet.

### DETAILED DESCRIPTION OF THE INVENTION

Embodiments of a segmented file system to protect data integrity and security are disclosed. The proliferation of Internet-based distributed data storage solutions has created a security issue. Even if an entire file system is not stored on a single computer, a single computer can store a significant portion of the file system (e.g. 64 MB in the GFS case). This data is generally stored contiguously to limit the number of accesses to different storage computers. For example, if a person wants 5 Kilo-bytes (KB) of data from the entire storage system, it is likely that in current file systems the data may be stored in one location, or if not, a significant portion of the data may be stored in one location. The single storage location generally will store files and data contiguously for ease of access. In other words, if a file is stored contiguously within the data storage location, a person, computer, or other entity with access to the storage location may be able to view the contiguous data and make sense of it. Thus, a malicious entity attempting to access stored contiguous data at a given storage location may be able to read, comprehend, and compromise the contiguous data.

Therefore, what is disclosed is a device, method, and system to protect Internet-based distributed data stored at insecure storage locations. In many embodiments, data segmentation logic, with the aid of a segmentation algorithm may segment (i.e. divide up) a data object to be stored in a file system. In different embodiments, a data object may comprise a file, a portion of a file, or several files. The segmentation algorithm, which may comprise one of a number of different security algorithms (e.g. digital spread spectrum), can take a contiguous data object, segment it into many different data segments and store the segments in a non-contiguous fashion across several storage locations. Thus, an entity at a given storage location viewing the segment stored at that particular location, would see a random portion or a random assortment of portions of the data object. The portions, when viewed solely from the perspective of an entity viewing the segment at the storage location, would resemble random, non-sensical data.

Once the data object has been segmented and each segment subsequently stored across several storage locations, data re-assembling logic may be provided with a re-assembly algorithm, which works in conjunction with the segmentation algorithm but reverses the process. The re-assembly algorithm may instruct the re-assembly logic as to which storage locations each segment of the data object is stored within and then, once all the segments have been retrieved, instructs the re-assembly logic, in what order to re-assemble the segments to reconstruct the original data object.

Reference in the following description and claims to “one embodiment” or “an embodiment” of the disclosed techniques means that a particular feature, structure, or characteristic described in connection with the embodiment is included in at least one embodiment of the disclosed techniques. Thus, the appearances of the phrase “in one embodiment” appearing in various places throughout the specification are not necessarily all referring to the same embodiment.

In the following description and claims, the terms “include” and “comprise,” along with their derivatives, may be used, and are intended to be treated as synonyms for each other. In addition, in the following description and claims, the terms “coupled” and “connected,” along with their derivatives may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

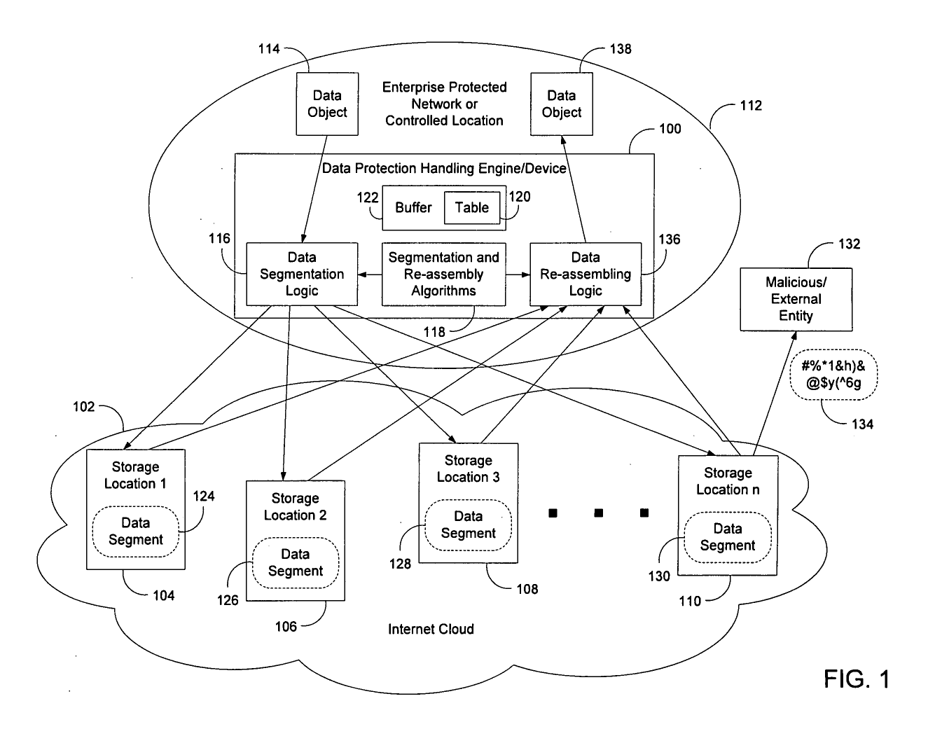

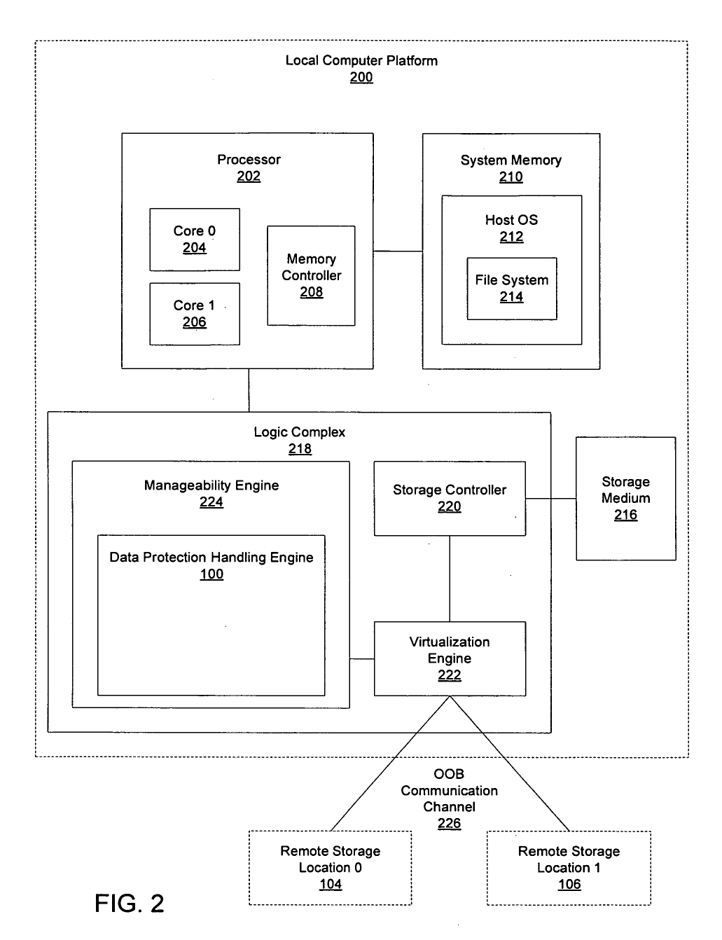

FIG. 1 illustrates an embodiment of a system to store and retrieve segmented data for protection of data integrity and security. The system includes a data protection handling engine 100. The protection handling engine 100 may be integrated in a computer system such as a desktop computer, server, workstation, mobile computer, handheld device, set top box, or any other type of computer system. The computer system is dicussed in greater detail below in relation to FIG. 2.

In many embodiments, the data protection handling engine 100 is communicatively coupled to Internet cloud 102, which is a representation of a cloud computing environment on the Internet, including several storage locations (storage locations 1 through n (104, 106, 108, and 110)). Each storage location may be any type of device or system capable of storing data, such as a desktop, server, or workstation computer also coupled to the Internet cloud 102. Additionally, each storage location may be geographically distributed around the globe.

The data protection handling engine 100 may be a part of an enterprise protected network or a controlled location 112. An enterprise protected network may be a security-monitored network within a corporation or other information technology (IT)-monitored network. The enterprise protected network may include a corporate firewall and other security mechanisms to keep computers located on within the protected network safe and trusted. In other embodiments, the data protection handling engine may not be within an enterprise protected network, but rather at a controlled location. The controlled location may be any location where the computer system housing the data protection handling engine 100 can be authenticated through hardware- or firmware-based security features.

In many embodiments, the data protection handling engine 100 is provided a data object 114 to store utilizing several storage locations on the Internet cloud 102. The data protection handling engine 100 receives the data object 114 at data segmentation logic 116. The data segmentation logic 116 utilizes a segmentation algorithm 118 to perform the segmentation of the data object 114 into several data segments.

The segmentation algorithm 118 is utilized by the data segmentation logic 116 as the instructions to segment and store the data. The segmentation algorithm 118 may include one or a combination of more than one algorithm. In different embodiments, the segmentation algorithm 118 may include implementing digital spread spectrum (DSS) technology, a secure hash algorithm (SHA), etc. For example, the data object 114 may be broken into a set number of segments. Each block may be a contiguous portion of the data, but during segmentation, that portion may be encrypted using a hash algorithm prior to being stored. In another embodiment, the data object 114 may again be broken into a set number of segments. Though, during segmentation, each segment is subdivided into a set of sub-segments. The set of sub-segments is stored in a random order in the stored data segment, dictated and known by the segmentation algorithm 118 alone. In yet another embodiment, the data object 114 may be initially segmented into a large number of sub-segments, which are then randomly sorted into each data segment (where a single data segment may be able to store many sub-segments. The data would be non-contiguous within each data segment. In even yet another embodiment, the non-contiguous sub-segments of data may be randomly sorted into the set of data segments to be stored, but prior to storage, the non-contiguous data segment may then be encrypted with a hash algorithm to further increase security.

There are many other distinct ways in which the data object may be segmented beyond the examples listed. An aspect of each segmentation technique is the result that each data segment, when viewed separately in the segmented format, is incomprehensible. In other words, the portions of the data object stored in a given data segment cannot be parsed or decrypted out of the segment to result in useful data for an entity viewing an individual stored data segment. The data segments are useless except to the data protection handling engine 100, which has access to the algorithm(s) utilized to segment the data, and thus, has access to the same reverse-process algorithm(s) to re-assemble the data into the original data object.

Furthermore, once the data object 114 has been segmented into a group of data segments, the segmentation algorithm then may instruct the data segmentation logic 116 where to store each data segment (e.g. storage locations 1 through n). In many embodiments there may be a pool of potential storage locations and the segmentation algorithm may utilize some form of assignment algorithm to instruct the data segmentation logic where to store each data segment. In some embodiments, the data protection handling engine 100 keeps a table 120 indicating the address of each storage location that is storing a data segment and which particular data segment is stored there. In many embodiments, the data protection handling engine 100 includes one or more buffers (e.g. buffer 122) utilized to help with the segmentation and re-assembly processes for storage space of segments and sub-segments. Additionally, a buffer may be utilized to store the table 120. In other embodiments that are not shown, the buffers utilized may be external to the data protection handling engine in a protected or private memory elsewhere in the computer system housing the data protection handling engine 100.

Once the data segments have been stored in the set of storage locations (e.g. data segment 124 stored at storage location 1 (104), data segment 126 stored at storage location 2 (106), data segment 128 stored at storage location 3 (108), and data segment 130 stored at storage location n (110)), the data segments may possibly be viewed individually by an external entity 132 who may or may not be malicious. Regardless of the intent of the external entity 132, the entity would not be able to comprehend any meaningful data stored in an individual data segment without the re-assembly algorithm 118 or the data from the other stored data segments (124, 126, and 128). Thus, the external entity 132 viewing data segment 130 may see incomprehensible data such as 134.

In many embodiments, each storage location is unaware of the location of each of the other storage locations. In many embodiments, each storage location is unaware of the existence of each of the other storage locations. In these embodiments, the data protection handling engine 100 may be the single entity aware of the existence and location of all storage locations. Thus, the external entity 132 would not be able to retrieve the location of another stored data segment by just having access to storage location n (130).

When a request is sent to the data protection handling engine 100 to retrieve a data object, the requester may require authentication. In some embodiments, the requester is a computer system located within the enterprise protected network 112. In these embodiments, the enterprise protected network 112 may have a verification process that takes place to verify that the computer is a safe computer within the protected network. In other embodiments, when the data protection handling engine 100 is located in a controlled location and a computer requesting the data object is external to the controlled location, a standard security authentication process may take place to validate the requester having the authority to request the data. This authentication process might comprise a public key encryption algorithm or another authentication mechanism.

Once the requester has been authenticated through whatever means necessary, the data protection handling engine 100 then begins the process of retrieving the data object from several storage locations across the Internet cloud 102. In many embodiments, the data re-assembling logic 136 utilizes the re-assembly algorithm 118 to reverse the segmentation and storage process that took place using the segmentation algorithm. The re-assembly algorithm instructs the data re-assembling logic 136 which storage locations are storing which data segments. In some embodiments, this information comes directly from the algorithm, in other embodiments, the data protection handling engine 100 stores a table of storage locations and segments stored to assist with the look-up (e.g. the table may be stored in internal storage space storing the segmentation and reassembly algorithms 118). Thus, the data re-assembling logic 136 gets the storage location information and retrieves the data segments from each storage location (e.g. data segment 124 stored at storage location 1 (104), data segment 126 stored at storage location 2 (106), data segment 128 stored at storage location 3 (108), and data segment 130 stored at storage location n (110)).

Once the data-reassembling logic has retrieved all data segments, the logic may be instructed by the re-assembly algorithm the manner in which to re-assemble the data segments. For example, if each segment is a contiguous portion of the data object and just encrypted, the re-assembly algorithm decrypts the segment and then puts each segment in order to recreate the object. In another example, if each segment comprises multiple sub-segments, the sub-segments are all removed from the respective data segments and sorted in a master order to recreate the data object. Many other possible re-assembly processes may exist.

When the data object has been fully restored to its original state, the data protection handling engine 100 can then provide the recreated original data object 138 to the authenticated requester.

FIG. 2 illustrates an embodiment of a computer system housing the data protection handling engine. The computer system 200 may include a processor, such as processor 102. In other embodiments that are not shown, the computer system 200 may include two or more processors. Processor 202 may be an Intel®-based central processing unit (CPU) or another brand CPU. In different embodiments, processor 202 may have one or more cores. For example, FIG. 2 shows processor 202 with two cores: core 0 (204) and core 1 (206).

Processor 202 is coupled to a memory subsystem through memory controller 208. Although FIG. 2 shows memory controller 208 integrated into processor 202, in other embodiments that are not shown, the memory controller may be integrated into a bridge device or other device in the computer system that is discrete from processor 202. The memory subsystem includes system memory 210 to store instructions to be executed by the processor. The memory devices in the memory subsystem may be any type of volatile dynamic random access memory (DRAM), for example double data rate (DDR) synchronous DRAM, and/or any type of non-volatile memory, for example a form of Flash memory. The processor(s) is coupled to the memory by a processor-memory interface, which may be a link (i.e. an interconnect/bus) that includes individual lines that can transmit data, address, control, and other information between the processor(s) and the memory.

The host operating system (OS) 212 is representative of an operating system that would be loaded into the memory of the computer system 200 while the system is operational to provide general operational control over the system and any peripherals attached to the system. The host OS 212 may be a form of Microsoft® Windows®, UNIX, LINUX, or any other functional OS. The host OS 212 provides an environment in which one or more programs, services, or agents can run within. In many embodiments, the host OS 212 includes a file system 214 which provides the specific structure for how files are stored in a storage medium, such as storage medium 216. The storage medium 216 may be one or more hard disk drives in some embodiments. In other embodiments, the storage medium 216 may be a large non-volatile memory drive. In yet other embodiments, the storage medium 216 may be a medium such as a tape drive, optical drive, or another drive. The storage medium 216 may store many of the files utilized within the local computer system 200. And as mentioned, the file system 214 provides a structure for how these files are stored. For example, the file system 214 may be a Microsoft® NTFS-based file system.

A logic complex 218 may include multiple integrated controllers for managing the memory subsystem and the I/O subsystem within the local computer system 200. Each subsystem coupled to the logic complex 218 may interface with the rest of the hardware within the local computer system 200 using one or more controllers. For example, if the storage medium 216 is a SATA (serial advanced technology attachment) hard drive, the storage controller 220 may be a SATA controller. The SATA controller 220 provides a communication interface between the hard disk drive and the rest of the local computer system 200. One or more drivers running within the local computer system 200 may communicate with the storage controller 220 to access the storage medium 216.

In many embodiments, the local computer system 100 employs a virtualization engine 222. The virtualization engine 222 allows the separation of the system into multiple virtual systems. The processor(s) can switch execution between these multiple virtual systems. The virtualization engine 222 includes logic to effectively allow the rest of the local computer system 200 (including the storage medium) to support multiple virtual systems. The virtualization engine 222 may include a driver for the storage controller 220 in some embodiments.

The logic complex 218 may also include a manageability engine 224 in many embodiments. In different embodiments, the manageability engine 224 may comprise a management device, management firmware, or other management logic within the local computer system 200 to assist in remote management processes related to the system. In many embodiments, the manageability engine 224 is an OOB management co-processor in the computer system that runs in parallel and independently of the one or more processor(s) in the local computer system 200.

In many embodiments, the logic complex 218 is a chipset. The chipset may include other control logic such as a memory controller to provide access to the system memory (when one is not provided in the processor 202 such as memory controller 208) and one or more I/O controllers to provide access to one or more I/O interconnects (i.e. links/busses). In these embodiments, the manageability engine 224 is integrated into the chipset. In some embodiments, the manageability engine 224 is integrated into a memory controller hub (MCH) portion of the chipset. In other embodiments that are not shown, the chipset (i.e. logic complex) is integrated into a central processor in the local computer system.

In many embodiments, the manageability engine 224 includes the data protection handling engine 100 (discussed in detail above in the discussion related to FIG. 1). By integrating the data protection handling engine into the manageability engine 224, the functionality of the data protection handling engine may be provided in a more secure and reliable fashion.

The data protection handling engine 100 may access remote storage locations, e.g. remote storage location 0 (104) and remote storage location 1 (106), through an out-of-band (OOB) communication channel 226. In different embodiments, the OOB communication channel 226 may comprise an interconnect, or a wireless network. The channel provides a secure interface to send information between the local computer system 200 each remote storage location. Due to the OOB nature of the channel, in many embodiments the OOB communication channel 226 is capable of transporting information to and from the local computer system when the local computer system 200 is not in a functioning or powered state. Therefore, the manageability engine may be operational to provide data segmentation storage and retrieval services with the data protection handling engine 100 even when the local computer system 200 is otherwise non-functional.

The manageability engine 224 may include firmware to store data segmentation and re-assembly logic. The segmentation and re-assembly logic (shown in FIG. 1 as blocks 116 and 136) may be provided access to local and remote storage locations through the virtualization engine 222.

The manageability engine 224 may also include the segmentation and re-assembly algorithms (shown in FIG. 1 as block 118) as well as any cryptographic keys and protocols associated with encrypting and decrypting the data segments. In other embodiments that are not shown, the algorithms and cryptographic keys and protocols may be embedded within another controller in the local computer system 200 that may be running an embedded operating system such as Linux or ThreadX.

Table 120 (in FIG. 1) may also be integrated into firmware storage in the manageability engine 224. The table 120 may include a list of data segment meta-data. As discussed above, the table 120 list may contain entries that map data objects to corresponding data segments stored in remote storage locations, as well as potentially locally within storage medium 216. The table may be maintained inside secure storage in the manageability engine firmware or elsewhere within the logic complex 218.

In many embodiments, firmware within the virtualization engine 222 may contain the disk driver for the storage controller 220 controller as well as, in some embodiments, logic related to disk encryption functionality. The virtualization engine 222 also may access remote storage locations through the OOB communication channel 226.

The firmware and hardware within the logic complex 218 could be used in a client mode or a server mode. In the case of client mode, the manageability engine 224 may run the data protection handling engine 100 logic for data segmentation & re-assembly and additionally interface with the remote storage locations which have been designated to store the data segments. In a server mode, the local computer system 200 may be turned into a data segment storage location. In this embodiment, the logic complex 218 could provide logic as it related to any data segments that were remotely stored within the storage medium 216 by a remote data protection handling engine located on a remote computer. The manageability engine 224 and virtualization engine 222 within the logic complex 218 may provide further secure storage service (including encryption) for particular data segments to be stored locally.

In other embodiments not shown in FIG. 2, the data protection handling engine 100 may be located in general system memory 210 and utilize in-band communication channels to communicate with each of the remote storage locations. These embodiments generally provide less security for data segment storage and retrieval, but if the local computer system 200 is secured within an enterprise protected network or in an otherwise securely controlled location (e.g. potentially utilizing network security features external to the local computer system 200), then in-band data segment storage and retrieval still may be secure.

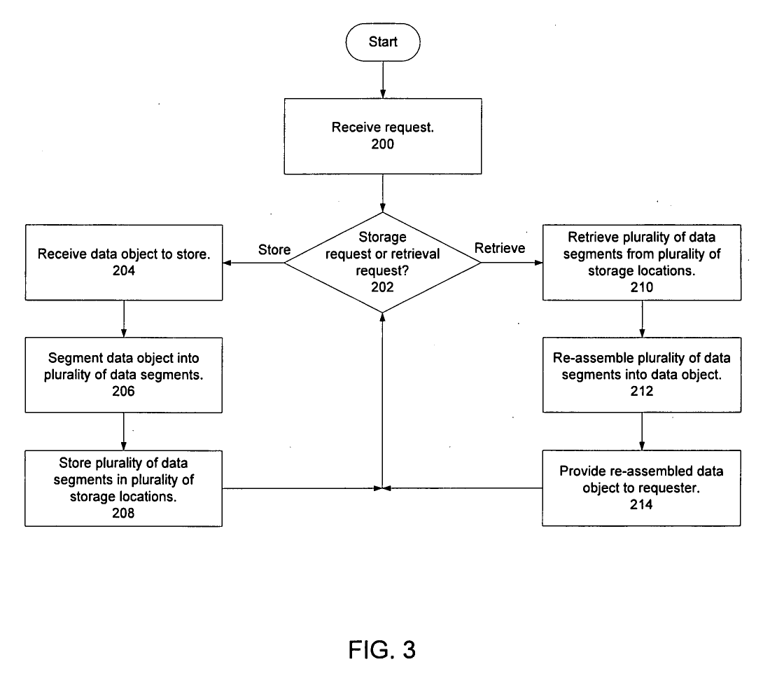

FIG. 3 is a flow diagram of an embodiment of a process to store and retrieve data objects in a protected segmented format in multiple locations across the Internet. The process is performed by processing logic that may comprise hardware, software, or a combination of both. The process begins by processing logic receiving a request (processing block 300). Processing logic then determines whether the request is to store a data object or retrieve a data object (processing block 302).

If the request is to store a data object, then processing logic receives the data object to store (processing block 304). Once processing logic has the data object, then processing logic segments the data object into multiple data segments (processing block 306). After the data object has been segmented into multiple data segments, then processing logic stores the data segments across multiple storage locations by sending each segment to a storage location (processing block 308) and the storage process is complete.

If the request is to retrieve a data object (with the assumption that the requester has already been verified as authorized to make the request to retrieve the data object), then processing logic retrieves the set of data segments from the multiple storage locations that the data segments are stored within (processing block 310). Once processing logic has retrieved all of the data segments, then processing logic can re-assemble the plurality of data segments into the requested data object (processing block 312). When the data object has been re-assembled, then processing logic can provide the data object to the requester (processing block 314) and the retrieval process is complete.

Thus, embodiments of a segmented file system to protect data integrity and security are disclosed. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A data protection handling device, comprising:
data segmentation logic to:
receive a data object to store;
segment the data object into a plurality of data segments, wherein each data segment comprises an incomprehensible portion the data object when viewed in the segmented format; and
send the plurality of data segments to a plurality of storage locations.

2. The device of claim 1, wherein the data segmentation logic is further operable to utilize a segmentation algorithm, accessible by the device, the segmentation algorithm to:
instruct the data segmentation logic the manner in which to segment the data; and
instruct the data segmentation logic which of the plurality of storage locations will store which of the plurality of data segments.

3. The device of claim 2, further comprising:
data re-assembling logic to:
receive a request for retrieval of the data object;
retrieve each of the plurality of data segments comprising the data object from the plurality of storage locations;
re-assemble the data object from the plurality of retrieved data segments; and
provide the re-assembled data object to an entity that sent the request.

4. The device of claim 3, wherein the data re-assembling logic is further operable to utilize a re-assembling algorithm, accessible by the device, the re-assembling algorithm to:
instruct the data re-assembling logic which of the plurality of storage locations store which of the plurality of data segments; and
instruct the data re-assembling logic the manner in which to assemble the plurality of retrieved data segments to recreate the data object.

5. The device of claim 3, wherein the data-reassembling logic is further operable to authenticate the entity requesting retrieval of the data object prior to allowing re-assembly to take place.

6. The device of claim 1, wherein each of the plurality of storage locations storing a data segment is unaware of the locations where each of the remaining data segments are stored.

7. The device of claim 1, wherein the incomprehensible portion of the data object stored in a given data segment includes a plurality of non-contiguous sub-segments of the data object.

8. A method, comprising:
receiving a data object to store;
segmenting the data object into a plurality of data segments, wherein each data segment comprises an incomprehensible portion the data object when viewed in the segmented format; and
sending the plurality of data segments to a plurality of storage locations.

9. The method of claim 8, further comprising:
determining the manner in which to segment the data; and
determining which of the plurality of storage locations will store which of the plurality of data segments.

10. The method of claim 9, further comprising:
receiving a request for retrieval of the data object;
retrieving each of the plurality of data segments comprising the data object from the plurality of storage locations;
re-assembling the data object from the plurality of retrieved data segments; and
providing the re-assembled data object to an entity that sent the request.

11. The method of claim 10, further comprising:
determining which of the plurality of storage locations store which of the plurality of data segments; and
determining the manner in which to assemble the plurality of retrieved data segments to recreate the data object.

12. The method of claim 10, further comprising:
authenticating the entity requesting retrieval of the data object prior to allowing re-assembly to take place.

13. The method of claim 8, wherein each of the plurality of storage locations storing a data segment is unaware of the locations where each of the remaining data segments are stored.

14. A system, comprising:
a requesting device to provide a data object to store;
a plurality of storage locations; and
a distributed data storage protection device to:
receive the data object;
segment the data object into a plurality of data segments, wherein each data segment comprises an incomprehensible portion the data object when viewed in the segmented format; and
send the plurality of data segments to the plurality of storage locations.

15. The system of claim 14, wherein the distributed data storage protection device is further operable to utilize a segmentation algorithm, the segmentation algorithm to:
instruct the distributed data storage protection device the manner in which to segment the data; and
instruct the distributed data storage protection device which of the plurality of storage locations will store which of the plurality of data segments.

16. The system of claim 15, wherein the distributed data storage protection device is further operable to:
receive a request for retrieval of the data object from an authenticated device;
retrieve each of the plurality of data segments comprising the data object from the plurality of storage locations;
re-assemble the data object from the plurality of retrieved data segments; and
provide the re-assembled data object to an entity that sent the request.

17. The system of claim 16, wherein the distributed data storage protection device is further operable to utilize a re-assembling algorithm, the re-assembling algorithm to:
instruct the distributed data storage protection device which of the plurality of storage locations store which of the plurality of data segments; and
instruct the distributed data storage protection device the manner in which to assemble the plurality of retrieved data segments to recreate the data object.

18. The system of claim 14, wherein each of the plurality of storage locations storing a data segment is unaware of the locations where each of the remaining data segments are stored.

19. The system of claim 14, further comprising:
a computer platform including a manageability engine, wherein the distributed data storage protection device is integrated into the manageability engine.

20. The system of claim 19, wherein the distributed data storage protection device sends the plurality of data segments to the plurality of storage locations through an out-of-band communication channel.
